(19) United States
(12) Patent Application Publication
(10) Pub. No.: US 2014/0141347 A1
(43) Pub. Date: May 22, 2014

(54) DEVICE FOR STORING DIOXYGEN AND/OR DIHYDROGEN AND RELATED FUEL CELL SYSTEM

(71) Applicant: Olivier Verdu, Les Milles (FR)

(72) Inventor: Olivier Verdu, Les Milles (FR)

(73) Assignee: AREVA Stockage d'Energie, Aix en Provence (FR)

(21) Appl. No.: 14/131,228

(22) PCT Filed: Jul. 5, 2012
(86) PCT No.: PCT/EP2012/063082

§ 371 Date: Feb. 6, 2014

(30) Foreign Application Priority Data
Jul. 8, 2011 (FR) 11 53231

(51) Int. Cl. H01M 8/04; H01M 8/06

(52) U.S. Cl. CPC H01M 8/04201; H01M 8/0656
USPC 429/422; 205/335; 429/513; 137/560; 137/1

(57) ABSTRACT

A device for producing and storing dioxygen and/or dihydrogen is provided. The device includes a source of dioxygen and dihydrogen, and a high pressure tank to store the dioxygen, respectively dihydrogen, at high pressure, in fluid communication with the source. The device further includes a bypass line connecting an outlet of dioxygen, respectively of dihydrogen, of the source with an outlet of dioxygen, respectively of dihydrogen, of the production and storage device, bypassing the high pressure tank, the bypass line being fed through a pressure regulator to reduce the pressure in the bypass line; and a device for measuring the concentration of dihydrogen, respectively of dioxygen, in the dioxygen respectively in the dihydrogen produced by the source, the measuring device being arranged on the bypass line.

The present invention concerns a device for producing and storing dioxygen and/or dihydrogen of the type comprising:
a source of dioxygen and dihydrogen; and
a high pressure tank to store the dioxygen, respectively the dihydrogen, under high pressure in fluid communication with the source.

### BACKGROUND

A said device is typically intended to feed a fuel cell to produce an electric current by redox reaction between the dioxygen and dihydrogen.

CN 101546842 describes a said device for producing and storing dioxygen and dihydrogen comprising an electrolyser to produce dioxygen and dihydrogen by electrolysis of water, a dioxygen tank and a dihydrogen tank, the production and storage device supplying a fuel cell.

However a said device does not give full satisfaction. At the time of water electrolysis there is a risk that molecules of dihydrogen are found in the flow of dioxygen leaving the electrolyser and conversely. The presence of these molecules of dihydrogen respectively of dioxygen carries a high explosion risk, in particular if the dioxygen respectively the dihydrogen is stored in the high pressure tank.

It is therefore necessary to control the concentration of dihydrogen in the dioxygen produced by the electrolyser, and conversely.

### SUMMARY OF THE INVENTION

It is one objective of the invention to propose a device for producing and storing dioxygen and/or dihydrogen having limited explosion risks, and having acceptable manufacturing and operating costs.

For this purpose the subject of the invention is a production and storage device of the aforementioned type further comprising:
a bypass line connecting an outlet of dioxygen, respectively of dihydrogen, of the source to an outlet of dioxygen respectively of dihydrogen of the production and storage device, bypassing the high pressure tank, the bypass line being fed through a pressure regulator to reduce the pressure in the bypass line; and
a device for measuring the concentration of dihydrogen, respectively of dioxygen, in the dioxygen respectively dihydrogen produced by the source, the measuring device being arranged on the bypass line.

In the preferred embodiments of the invention, the production and storage device also comprises one or more of the following characteristics taken alone or in any possible technical combination thereof:
the production and storage device comprises a low pressure line placing the high pressure tank in fluid communication with the outlet of dioxygen respectively of dihydrogen of the production and storage device, the bypass line leading into the low pressure line, the low pressure line being adapted to store the dioxygen respectively the dihydrogen transiting through the bypass line;
the low pressure line comprises a low pressure tank to store the dioxygen respectively the dihydrogen transiting through the bypass line;
the source of dioxygen respectively of dihydrogen is an electrolyser.

A further subject of the invention is a fuel cell system comprising a fuel cell adapted to produce an electric current by redox reaction between dioxygen and dihydrogen, and a device feeding the fuel cell with dioxygen and dihydrogen, wherein the feed device comprises a production and storage device such as defined above.

A further subject of the invention is a method for producing and storing dioxygen and/or dihydrogen comprising the following successive steps:
producing dioxygen and dihydrogen;
storing the produced dioxygen, respectively dihydrogen, in a high pressure tank; and;
expanding the dioxygen, respectively dihydrogen, leaving the high pressure tank to feed a device with dioxygen respectively with dihydrogen at low pressure;

the method further comprising the following successive steps:
sampling a portion of the produced dioxygen, respectively a portion of the produced dihydrogen before storage in the high pressure tank;
expanding the said portion of dioxygen, respectively of dihydrogen;
measuring the concentration of dihydrogen, respectively of dioxygen, in the expanded portion of dioxygen, respectively of dihydrogen; and
mixing the portion of dioxygen, respectively the portion of dihydrogen, with the dioxygen respectively dihydrogen leaving the high pressure tank.

### BRIEF SUMMARY OF THE DRAWINGS

Other characteristics and advantages of the invention will become apparent on reading the following description given solely as an example and with reference to the appended drawings in which:

FIG. 1 schematically illustrates a fuel cell system according to an embodiment of the invention;

FIG. 2 is a schematic cross-sectional view of one cell in a fuel cell of the fuel cell system in FIG. 1; and

FIG. 3 is a detailed schematic of a feed device feeding the fuel cell system in FIG. 1.

### DETAILED DESCRIPTION

In the remainder hereof the terms <<upstream>> and <<downstream>> are to be construed in the direction of flow of the fluids in the different fluid circuits.

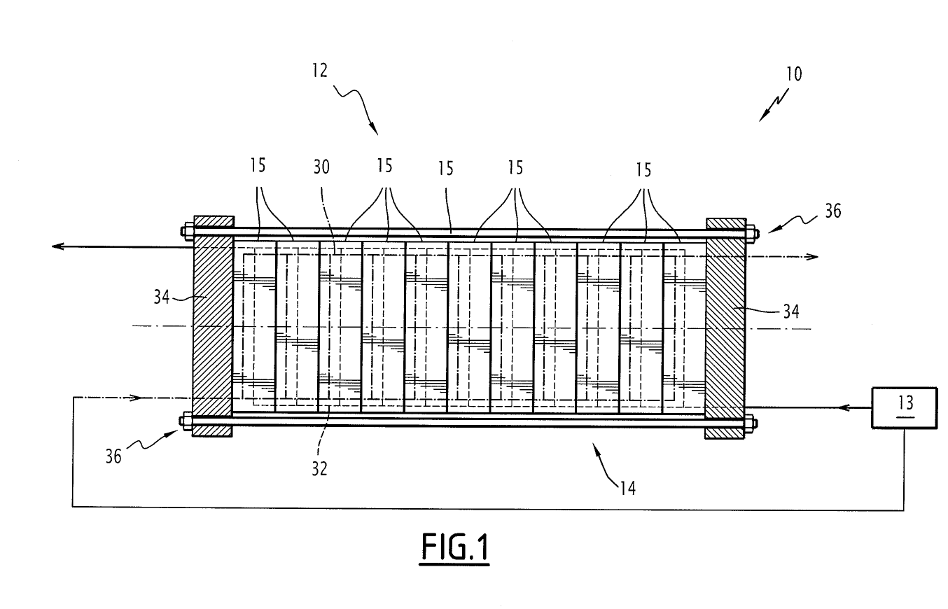

The fuel cell system 10 illustrated in FIG. 1 comprises a fuel cell 12 to produce electric current by redox reaction between an oxidising fluid and a reducing fluid, and a feed system 13 to feed the fuel cell 12 with oxidising fluid and reducing fluid.

The fuel cell 12 comprises a stack 14 of cells 15. As a variant (not illustrated) the fuel cell 12 comprises several stacks 14 in fluid communication with one another, in parallel or in series.

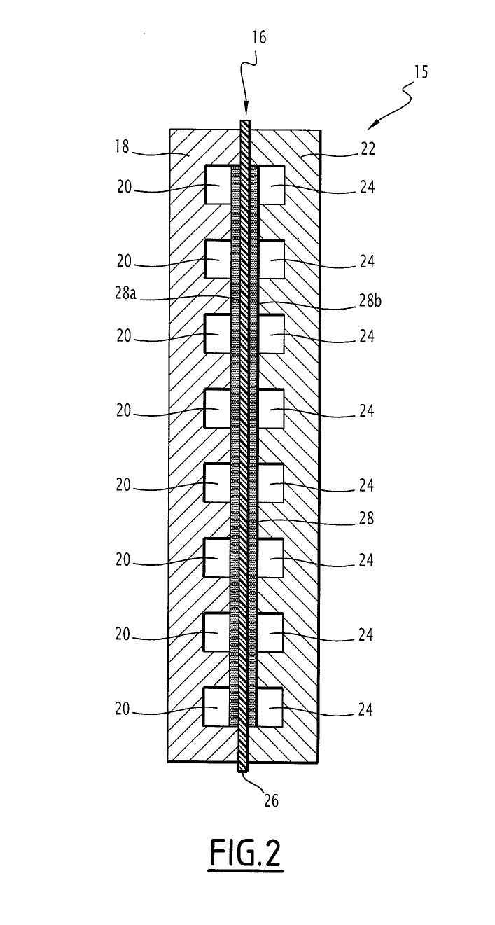

One cell 15 of the stack 14 is illustrated in FIG. 2. It comprises a membrane-electrode assembly 16 inserted between an anode plate 18 and a cathode plate 22.

The membrane-electrode assembly 16 comprises an ion exchange membrane 26 sandwiched between an anode 28a and a cathode 28b.

The membrane 26 electrically insulates the anode 28a from the cathode 28b.

The membrane 26 is generally a proton exchange membrane, adapted so as only to allow the passing of protons. The membrane 26 is typically in polymer material.

The anode 28a and the cathode 28b each comprise a catalyst, typically platinum or platinum alloy to facilitate the reaction.

The anode plate 18 delimits an anodic conduit 20 for circulation of the reducing fluid along the anode 28a and in contact therewith. For this purpose, the plate 18 is provided with at least one channel arranged in the surface of the plate facing the membrane-electrode assembly 16 and closed by the said membrane-electrode assembly 16. The anode plate 18 is formed of an electrically conductive material, typically graphite. The reducing fluid used is a fluid comprising dihydrogen, e.g., pure dihydrogen.

The cathode plate 22 delimits a cathode conduit 24 for circulation of the oxidising fluid along the cathode 28b and in contact therewith. For this purpose, the plate 22 is provided with at least one channel arranged in the surface of the plate facing the membrane-electrode assembly 16 and closed by the said membrane-electrode assembly 16. The cathode plate 22 is formed of an electrically conductive material, typically graphite. The oxidising fluid used is a fluid comprising dioxygen, e.g., pure dioxygen or a mixture of air and dioxygen.

The membrane 26 separates the oxidising and reducing fluids. It is arranged between the anode plate 18 and the cathode plate 22 of the cell 15 and insulates these electrically from one another.

The anode 28a is in electric contact with the anode plate 18. The cathode 28b is in electric contact with the cathode plate 22. It is at the anode 28a that oxidation of the reducing fluid takes place and where the electrons and protons are generated. The electrons then transit via the anode plate 18 towards the cathode 28b of the cell 15, or towards the cathode of another cell, to take part in reducing the oxidising fluid.

In the stack 14, the anode plate 18 of each cell is in contact with the cathode plate 22 of the neighbouring cell. The anode and cathode plates 18, 22 therefore ensure the transfer of the electrons from the reducing fluid circulating in a cell towards the oxidising fluid circulating in another cell. The anode 18 and cathode 22 plates of two neighbouring cells of the stack 18 are preferably made in one piece and together form a bipolar plate.

Returning to FIG. 1, the anode conduits 20 of the cells 15 are in fluid communication with each other and together form an anode compartment 30 of the stack 14, and the cathode conduits 22 of the cells 15 are in fluid communication with one another and together form a cathode compartment 32 of the stack 14. In FIG. 1, the anode compartment 30 is schematically illustrated by a dashed line and the cathode compartment 32 is schematically illustrated by a chain dotted line.

The cells 15 are held together in a stack by means of clamping plates 34 arranged at the ends of the stack 14. Clamping bolts 36 apply a clamping force on the plates 34 to hold them compressed against the cells 15.

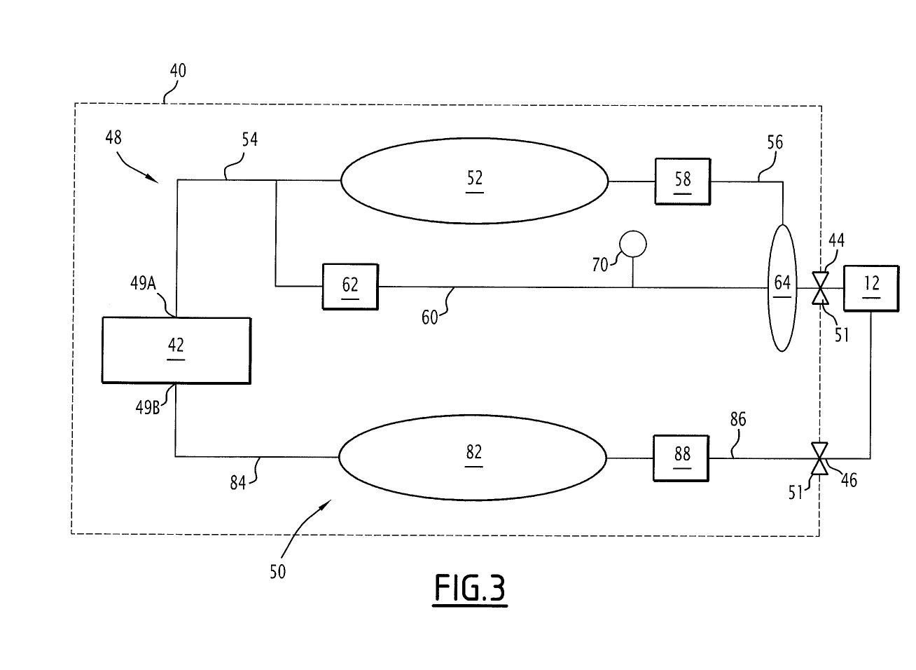

The feed system 13 is adapted to feed the anode compartment 30 with reducing fluid and the cathode compartment 32 with oxidising fluid. It comprises a device 40 for producing and storing dioxygen and dihydrogen illustrated in FIG. 3.

The production and storage device 40 comprises a source 42 of dioxygen and dihydrogen, a dioxygen outlet 44, a dihydrogen outlet 46, a first fluid circuit 48 connecting a dioxygen outlet 49A of the source 42 with dioxygen outlet 44, and a second fluid circuit 50 connecting a dihydrogen outlet 49B of the source 42 with dihydrogen outlet 46.

The source 42 is typically an electrolyser adapted to produce dioxygen and dihydrogen by electrolysis. Preferably, the dioxygen and dihydrogen are produced by the source 42 at high pressures.

The outlets of dioxygen 44 and dihydrogen 46 each comprise a valve 51 for the selective opening of the outlets 44, 46 respectively. Therefore the dioxygen and dihydrogen produced can be stored in the device 40 before being fed to the fuel cell 12.

The first fluid circuit 48 comprises a first high pressure tank 52 to store the dioxygen under high pressure, a high pressure channel line 54 placing the source 42 in fluid communication with the first high pressure tank 52, and a low pressure channel line 56 placing the high pressure tank 52 in fluid communication with the dioxygen outlet 44.

The high pressure line 54 is adapted to lead the dioxygen produced by the source 42 at high pressure to the high pressure tank 52.

The low pressure line 56 is adapted to lead the produced dioxygen under regulated pressure from the tank 52 to the outlet 44. The first fluid circuit 48 comprises a pressure regulator 58 arranged at the outlet of the high pressure tank 52 to reduce the pressure of the dioxygen in the low pressure line 56 compared with the storage pressure of the dioxygen in the high pressure tank 52.

The first fluid circuit 48 further comprises a bypass line 60 placing the dioxygen outlet 49A of the source 42 in fluid communication with the dioxygen outlet 44 of the production and storage device 40. The bypass line 60 is installed to bypass the high pressure tank 52, i.e., it is adapted so that part of the dioxygen produced by the source 42 meets the dioxygen outlet 44 without passing through the high pressure tank 52.

The bypass line 60 is fed in the high pressure line 54 upstream of the tank 52, and leads into the low pressure line 56. In particular, it is supplied in the high pressure line 54 via a pressure regulator 62, intended to reduce the pressure in the bypass line 60 compared with the dioxygen pressure in the high pressure line 54.

The low pressure line 56 is adapted to store the dioxygen having transited through the bypass line 60. For this purpose, it preferably comprises, as illustrated, a low pressure tank 64. The low pressure tank 64 is typically formed by a local widening of the low pressure line 56.

As previously mentioned, part of the dihydrogen produced is present in the dioxygen conveyed by the first fluid circuit 48. It is necessary to measure the concentration of the dihydrogen in the dioxygen to limit risks of explosion. For this purpose, the production and storage device 40 also comprises a device 70 for measuring the concentration of dihydrogen in the dioxygen produced by the source 42.

The measuring device 70 is arranged on the bypass line 60 at low pressure. Therefore, the measuring device is adapted to measure at low pressure the concentration of dihydrogen in the dioxygen, and relatively low-cost measuring devices can be used to obtain the measuring device 70.

Preferably, the production and storage device 40 also comprises a module (not illustrated) adapted to regulate the electrolysis reaction at the source 42 as a function of the dihydrogen concentration measured by the measuring device 70.

The second fluid circuit 50 comprises a second high pressure tank 82 to store the dihydrogen under high pressure, a high pressure channel line 84 placing the source 42 in fluid communication with the second high pressure tank 82, and a low pressure channel line 86 connecting the high pressure tank 82 with the dihydrogen outlet 46.

The high pressure line 84 is adapted to lead the dihydrogen produced by the source 42 at high pressure to the high pressure tank 82.

The low pressure line 86 is adapted to lead the produced dihydrogen, under regulated pressure, from the tank 82 to the outlet 46. The second fluid circuit 50 comprises a pressure regulator 88 at the outlet of the tank 82 to reduce the dihydrogen pressure in the low pressure line 86 compared with the dihydrogen storage pressure in the high pressure tank 82. A description will now be given of a method for feeding the fuel cell 12 by the production and storage device 40 with reference to FIG. 3.

Initially, the source 42 produces dioxygen and dihydrogen by electrolysis and the valves 51 are each in closed configuration. The dihydrogen produced is stored in the second high pressure tank 82. Most of the dioxygen produced is stored in the first high pressure tank 52. During this time, a small portion of the dioxygen produced is taken from the high pressure line 54, it is expanded through the pressure regulator 62 and transits via the bypass line 60 in which the concentration of dihydrogen in the produced dioxygen is measured by the device 70, before the small portion of dioxygen is stored in the low pressure line 56.

At a second stage, the valves 51 are switched over to open configuration. The stored dioxygen and dihydrogen flow out of the tanks 52, 82 and are expanded through the pressure regulators 58, 88. The dioxygen leaving the tank 52 then mixes with the small portion of dioxygen stored in the low pressure line 56. Thereafter the dioxygen and dihydrogen leave the production and storage device 40 through outlet 44 and outlet 46 respectively. Preferably the source 42 does not produce dioxygen and dihydrogen during this second stage.

By feeding the fuel cell 12 by the production and storage device 40, it is therefore possible to measure the concentration of dihydrogen in the dioxygen produced, at low production and operating costs. The measuring device used can effectively be low-cost since measurement is performed at low pressure. In addition, the gas used to measure the concentration of dihydrogen is also used to feed the fuel cell, which allows the limiting of gas losses and hence a reduction in operating costs.

Additionally, since the concentration of dihydrogen in the dioxygen is measured by taking a sample from the flow of dioxygen upstream of the high pressure tank, this makes it possible for the dihydrogen concentration to be measured directly during the filling of the high pressure tank and without any risk of dihydrogen dilution in a fluid lying stagnant in the fluid circuit.

In the example given above, only the concentration of dihydrogen in the produced dioxygen is measured. As a variant (not illustrated) the second fluid circuit 50 comprises a device for measuring the concentration of dioxygen in the dihydrogen, and the second fluid circuit 50 is conformed in similar manner to the first fluid circuit 48 so as to allow measurement of the dioxygen concentration at low pressure and without fluid loss.

As a further variant (not illustrated) only the second fluid circuit 50 is adapted to allow measurement of the concentration of dioxygen in the produced dihydrogen, at low pressure and without fluid loss; the first fluid circuit 48 then not comprising the bypass line 60.

What is claimed is:

1-6. (canceled)

7. A production and storage device for producing and storing dioxygen, comprising:
a source of dioxygen and dihydrogen;
a high pressure tank to store the dioxygen at high pressure, the high pressure tank being in fluid communication with the source,
a bypass line connecting an outlet of the dioxygen of the source with an outlet of the dioxygen of the production and storage device, bypassing the high pressure tank, the bypass line being fed through a pressure regulator to reduce the pressure in the bypass line; and
a device for measuring the concentration of dihydrogen in the dioxygen produced by the source, the measuring device being arranged on the bypass line.

8. The production and storage device as recited in claim 7 further comprising a low pressure line placing the high pressure tank in fluid communication with the outlet of the dioxygen of the production and storage device, the bypass line leading into the low pressure line, the low pressure line being adapted to store the dioxygen transiting through the bypass line.

9. The production and storage device as recited in claim 8 wherein the low pressure line comprises a low pressure tank to store the dioxygen transiting through the bypass line.

10. The production and storage device as recited in claim 9 wherein the source of the dioxygen and the dihydrogen is an electrolyser.

11. A fuel cell system comprising:
a fuel cell adapted to produce an electric current by redox reaction between dioxygen and dihydrogen; and
a device feeding the fuel cell with dioxygen and dihydrogen including the production and storage device as recited in claim 7.

12. A method for producing and storing dioxygen comprising the following steps:
producing dioxygen and dihydrogen;
storing the produced dioxygen in a high pressure tank;
expanding the dioxygen at an outlet of the high pressure tank to feed a device with the dioxygen at low pressure,
sampling a portion of the produced dioxygen before storage in the high pressure tank;
expanding the sampled portion of the dioxygen;
measuring the concentration of dihydrogen included in the expanded portion of the dioxygen; and
mixing the expanded portion of the dioxygen with the dioxygen output from the high pressure tank.

13. A production and storage device for producing and storing dihydrogen, comprising:
a source of dioxygen and dihydrogen;
a high pressure tank to store the dihydrogen at high pressure, the high pressure tank being in fluid communication with the source,
a bypass line connecting an outlet of the dihydrogen of the source with an outlet of the dihydrogen of the production and storage device, bypassing the high pressure tank, the bypass line being fed through a pressure regulator to reduce the pressure in the bypass line; and
a device for measuring the concentration of dioxygen in the dihydrogen produced by the source, the measuring device being arranged on the bypass line.

14. The production and storage device as recited in claim 13 further comprising a low pressure line placing the high pressure tank in fluid communication with the outlet of the dihydrogen of the production and storage device, the bypass line leading into the low pressure line, the low pressure line being adapted to store the dihydrogen transiting through the bypass line.

15. The production and storage device as recited in claim 8 wherein the low pressure line comprises a low pressure tank to store the dihydrogen transiting through the bypass line.

16. The production and storage device as recited in claim 15 wherein the source of the dioxygen and the dihydrogen is an electrolyser.

17. A fuel cell system comprising:
a fuel cell adapted to produce an electric current by redox reaction between dioxygen and dihydrogen; and
a device feeding the fuel cell with dioxygen and dihydrogen including the production and storage device as recited in claim 13.

18. A method for producing and storing dihydrogen comprising the following steps:
producing dioxygen and dihydrogen;
storing the produced dihydrogen in a high pressure tank;
expanding the dihydrogen at an outlet of the high pressure tank to feed a device with the dihydrogen at low pressure,
sampling a portion of the produced dihydrogen before storage in the high pressure tank;
expanding the sampled portion of the dihydrogen;
measuring the concentration of dioxygen included in the expanded portion of the dihydrogen; and
mixing the expanded portion of the dihydrogen with the dihydrogen output from the high pressure tank.
